(19) United States
(12) Patent Application Publication
(10) Pub. No.: US 2007/0097297 A1
(43) Pub. Date: May 3, 2007

(54) LIQUID CRYSTAL DISPLAY DEVICE

(75) Inventors: Yasushi KAWATA, Ageo-shi (JP); Akio Murayama, Fukaya-shi (JP); Kisako Ninomiya, Fukaya-shi (JP); Norihiro Yoshida, Kumagaya-shi (JP); Chigusa Tago, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology, Minato-ku (JP)

(21) Appl. No.: 11/548,497

(22) Filed: Oct. 11, 2006

(30) Foreign Application Priority Data
Oct. 27, 2005 (JP) 2005-313139

(51) Int. Cl. G02F 1/1335

(52) U.S. Cl. 349/114

(57) ABSTRACT

Transmissive display regions are disposed at both sides of a reflective region in each pixel so as to sandwich the reflective region therebetween. A first height adjusting layer is formed below a counter electrode of a counter substrate, whereby the thickness of a liquid crystal layer in the reflective display region is made smaller than the thickness of the transmissive display regions. The motion of liquid crystal molecules at the peripheral edge of the reflective display region and the motion of liquid crystal molecules at the peripheral edge of the transmissive display region are symmetrical at both sides of the reflective display region. The alignment stability of the liquid crystal in the pixel can be enhanced. Defects such as unevenness of display caused by fluctuation of alignment of the liquid crystal molecules in the liquid crystal layer can be avoided. The asymmetrical property of the field-of-view angle can be avoided.

### INCORPORATION BY REFERENCE

The present application claims priority under 35 U.S.C. §119 to Japanese Patent Application No. 2005-313139 filed on Oct. 27, 2005. The content of the application is incorporated herein by reference in its entirety.

### FIELD OF THE INVENTION

The present invention relates to a liquid crystal display device in which a liquid crystal layer is interposed between an array substrate and a counter substrate.

### BACKGROUND OF THE INVENTION

These types of liquid crystal display devices use liquid crystal elements and have features such as lightness in weight, thin design, low power consumption, etc., and thus they have been used in various fields such as OA equipment, information terminal devices, clocks, television sets, etc. Particularly, among liquid crystal display devices, liquid crystal display devices using thin film transistor (TFT) elements have been used as display devices for cellular phones, television sets, computers, etc., in terms of its excellent adaptability.

In connection with the compact and light design of information terminal devices, high resolution display devices having a wide field-of-view angle have been recently demanded. The high resolution design is performed by enhancing the miniaturization of the structure of the array substrate on which the TFT elements are provided. With respect to the field-of-view angle, there is known a display device having a liquid crystal mode having a wide field-of-view angle which uses the OCB (Optically Compensated Bend) system using nematic liquid crystal, MVA (Multi-domain Vertical Alignment) system or IPS (In-Plane Switching: transverse electric field) system.

Recently, display devices have been more frequently used outdoors. Therefore, in addition to a transmissive display system for enabling display by using transmitted light, a semi-transmissive type liquid crystal display system having a liquid crystal mode in which semi-transmissive display can be performed has been put into practical use. This semi-transmissive type liquid crystal display system has a reflective display system for enabling display by using partially reflected light. Furthermore, it has been increasingly demanded to provide a high-performance liquid crystal display having a wide field-of-view angle and excellent visibility for outdoor use by combining the liquid crystal mode having the wide field-of-view angle and the liquid crystal mode in which the semi-transmissive display can be performed.

Particularly, in the semi-transmissive type liquid crystal display device in which both the transmissive display and the reflective display can be performed, it is required to independently control the thickness of the liquid crystal layer in each of a transmittance region in which the transmissive display can be performed and a reflective region in which the reflective display can be performed. In general, a convex-shaped projecting portion is provided at a portion facing a reflective region under a counter electrode for applying a voltage to the liquid crystal layer between an array substrate and a counter substrate disposed so as to face the array substrate so that the thickness of the liquid crystal layer in this reflective region is controlled. Therefore, a step of forming the projecting portion must be added.

Furthermore, in a liquid crystal display device based on the MVA system in which alignment division is carried out by a dielectric structure formed of resist material or the like, it is required that an alignment controlling convex-shaped dielectric layer inherent to the MVA system and a convex-shaped dielectric layer for adjusting the thickness of the liquid crystal layer in the reflective region are formed independently above and below the pixel electrode of the array substrate. Accordingly, the number of process steps or the number of masks which are required to manufacture this liquid crystal display is increased, and the number of the managing items such as film thickness control, etc., is increased. Therefore, it is not easy to enhance the stability of alignment of liquid crystal alignment in the pixels, and thus it is not easy to avoid defects such as unevenness of display, etc., so that it is not easy to enhance display quality.

The present invention has been made in the view of the above-mentioned problems, and it is an object to provide a liquid crystal display device with excellent visual quality.

### SUMMARY OF THE INVENTION

A liquid crystal display device according to the present invention including an array substrate having a light-transmissible substrate, a plurality of pixels provided in a matrix form on one principal surface of the light-transmissible substrate, a reflective region that is provided to each of the plurality of pixels and visible by using reflection of light, and transmittance regions that are provided at both sides of the reflective region so as to sandwich the reflective region therebetween and visible by using transmission of light; a counter substrate having a light-transmissible substrate that is disposed so as to face the one principal surface of the light-transmissible substrate of the array substrate; and a liquid crystal layer that is interposed between the array substrate and the counter substrate and has a thickness in the reflective region that is smaller than that of the transmittance regions.

The transmittance regions are provided at both sides of the reflective region that sandwiches the reflective region for each of a plurality of pixels provided in a matrix form on one principal surface of the light-transmissible substrate of the array substrate, and the thickness of the liquid crystal layer in the reflective region is smaller than the thickness of the liquid crystal layer in the transmittance region.

As a result, even when the thickness in the reflective region of the liquid crystal layer is smaller than the thickness in the transmittance region, since the transmittance regions are provided at both sides of the reflective region that sandwiches the reflective region for each of a plurality of pixels, the motion of the liquid crystal molecules in the liquid crystal layer in the transmittance regions are symmetrical with respect to the reflective region side located between the transmittance regions. Therefore, the alignment stability in each of the plurality of pixels can be enhanced, and the unevenness of display caused by alignment fluctuation can be avoided and the symmetry of the field-of-view angle can be secured, so that the display quality level can be enhanced.

### BRIEF DESCRIPTION OF THE DRAWINGS

FIG. 1 is an explanatory cross-sectional view showing a part of a first embodiment of a liquid crystal display device according to the present invention;

FIG. 2 is an explanatory plan view showing a part of an array substrate of the liquid crystal display device;

FIG. 3 is an explanatory plan view showing a part of a counter substrate of the liquid crystal display device;

FIG. 4 is a graph showing a CR field-of-view angle of the liquid crystal device;

FIG. 5 is an explanatory cross-sectional view showing a part of a second embodiment of the liquid crystal display device according to the present invention;

FIG. 6 is an explanatory plan view showing a part of an array substrate of the liquid crystal display device;

FIG. 7 is a plan view showing a part of a counter substrate of the liquid crystal display device;

FIG. 8 is a graph showing a CR field-of-view angle of the liquid crystal display device;

FIG. 9 is an explanatory cross-sectional view showing a part of a liquid crystal display device of a comparative example;

FIG. 10 is an explanatory plan view showing a part of the array substrate of the liquid crystal display device;

FIG. 11 is an explanatory plan view showing a part of the counter substrate of the liquid crystal display device; and

FIG. 12 is a graph showing the CR field-of-view angle of the liquid crystal display device.

### DETAILED DESCRIPTION OF THE PREFERRED EMBODIMENT

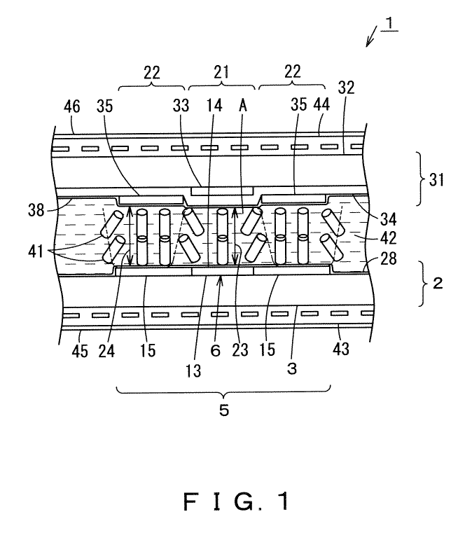

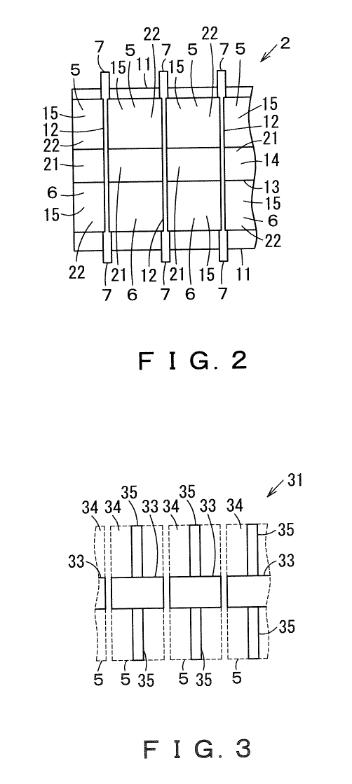

A first embodiment of a liquid crystal display device according to the present invention will be hereunder described with reference to FIG. 1 to FIG. 3.

In FIG. 1 to FIG. 3, numeral 1 represents a liquid crystal cell as a liquid crystal display device, and the liquid crystal cell 1 is a semi-transmissive type liquid crystal display device having a wide field-of-view angle. The liquid crystal cell 1 is a display device having a vertical alignment type liquid crystal mode using a wide field-of-view angle mode called an MVA (Multi-domain Vertical Alignment) system.

The liquid crystal cell 1 includes a substantially rectangular flat plate type array substrate 2. The array substrate 2 has a substantially transparent and rectangular flat plate type glass substrate 3. This glass substrate 3 has a light transmissible substrate as a transparent substrate having translucency and electrical insulation properties. A plurality of pixels 5 are arranged in a matrix form on the surface as one principal surface of the glass substrate 3. Each of the plurality of pixels 5 is designed to have a slender rectangular shape in plan view which is elongated along the longitudinal direction of the glass substrate 3. A pixel electrode 6, an auxiliary capacity (not shown) corresponding to a pixel auxiliary capacitor as an accumulating capacitor and a thin film transistor (TFT) 7 are arranged as one-pixel elements one by one in each of the plurality of pixels 5.

Furthermore, a plurality of scanning lines 11 corresponding to gate lines as first wires are arranged on the glass substrate 3 along the lateral direction of the glass substrate 3. These scanning lines 11 are gate electrode wires formed of electrically conductive film, and spaced from one another at equal intervals parallel along the lateral direction of the glass substrate 3. Furthermore, on the glass substrate 3, a plurality of signal lines 12 as second wires are arranged along the longitudinal direction of the glass substrate 3. These signal lines 12 are pixel signal wires as electrode wires formed of electrically conductive film, and spaced from one another at equal intervals parallel along the lateral direction of the glass substrate 3. The scanning lines 11 and the signal lines 12 are prepared by forming electrically conductive film according to a sputtering method or the like and then patterning the electrically conductive film.

The scanning lines 11 and the signal lines 12 are wired in lattice form on the glass substrate 3 so as to orthogonally intersect one another. Each pixel 5 is provided in each of the rectangular regions surrounded by the scanning lines 11 and the signal lines 12. Furthermore, a pixel electrode 6, an auxiliary capacitor and a thin film transistor 7 are provided for every pixel 5 in connection with each of the intersecting points between the scanning lines 11 and the signal lines 12.

Furthermore, auxiliary capacitance (Cs) lines 13 as capacitance lines corresponding to a plurality of metal electrodes extending along the longitudinal direction of the scanning lines 11 are arranged along the lateral direction of the glass substrate 3 between the scanning lines 11 on the glass substrate 3. These auxiliary capacitance lines 13 are provided substantially at the approximately midway point between the scanning lines 11 along the longitudinal direction of the glass substrate 3 so as to be spaced parallel from the scanning lines 11. The auxiliary capacitance line 13 is electrically connected to the auxiliary capacitor provided in each pixel 5. Furthermore, the auxiliary capacitance line 13 constitutes a part of the pixel electrode 6 provided in each pixel 5. Still furthermore, a reflection face 14 for reflecting light incident to the surface of the auxiliary capacitance line 13 is formed on the surface as one principal surface of the auxiliary capacitance line 13.

The pixel electrodes 6 of the respective pixels 5 are provided in rectangular regions partitioned by the plurality of scanning lines 11 and the signal lines 12. Transparent electrodes 15 connected with the auxiliary capacitance line 13 are laminated at both side portions of the auxiliary capacitance line 13 of the pixel electrode 6. These transparent electrodes 15 are transmissive pixel electrodes formed of transparent ITO (Indium Tin Oxide), and respectively cover the regions between the signal lines 12 at both sides of the auxiliary capacitance line 13 in each pixel. Accordingly, the transparent electrodes 15 are provided at both side portions sandwiching the auxiliary capacitance line 13 of each pixel 5, and laminated in the same layer as the auxiliary capacitance line 13. Furthermore, the transparent electrodes 15 are formed to be smaller in thickness than the auxiliary capacitance line 13. Accordingly, the reflection face 14 of the auxiliary capacitance line 13 is designed to project in a convex shape with respect to the surfaces of the transparent electrodes 15.

Here, the region in which the auxiliary capacitance line 13 in each pixel 5 is laminated serves as a reflective display region 21 as a reflective region for enabling visible reflection type display by using reflection of light. That is, the reflective display region 21 is a region which can be visualized in accordance with reflection or non-reflection of light from the reflection face 14 of the auxiliary capacity line 13. Furthermore, the region in which the transparent electrode 15 is laminated in each pixel 5 serves as a transmissive display region 22 as a transmittance region for enabling visible transmission type display by using transmission of light. That is, the transmissive display region 22 is a region which is visualized in accordance with transmission or non-transmission of light at the transparent electrode 15.

Accordingly, in each pixel 5, the reflective display region 21 is provided at the midway point in the longitudinal direction of the pixel electrode 6 in each pixel 5 so as to be arranged in a rectangular flat plate shape that extends the entire the lateral direction of each pixel 5. Accordingly, the liquid crystal cell 1 is provided with the reflective display region 21 and the transmissive display region 22 in each pixel 5, and thus it is designed as a semi-transmissive type having the reflective display region 21 and the transmissive display region 22.

Furthermore, in each pixel 5, the transmissive display regions 22 are provided to both side portions along the longitudinal direction of the pixel electrode 6 of the reflective display region 21 so as to be arranged in a rectangular flat plate shape that extends the entire the lateral direction of each pixel 5. Therefore, the transmissive display regions 22 are provided at both sides of the reflective display region 21 symmetrically, that is, linearly symmetrically.

Alignment film 28 is laminated on the glass substrate 3 containing each pixel electrode 6 formed by an alignment processing of polyimide. The alignment film 28 is formed by subjecting the surface of the glass substrate 3 covering the pixel electrode 6 to alignment means. The alignment film 28 is an alignment processing layer formed by coating vertical alignment film at a film thickness ranging, for example, from 70 nm to 90 nm. The alignment film 28 is subjected to an alignment processing in a fixed direction, and covers each of the pixel electrode 6, the thin film transistor 7, the scanning line 11, the signal line 12 and the auxiliary capacitance line 13 in each pixel 5.

On the other hand, a rectangular flat plate type counter substrate 31 is disposed as a common substrate so as to face the array substrate 2. The counter substrate 31 is equipped with a substantially transparent rectangular flat plate type glass substrate 32. The glass substrate 32 is a translucent substrate as a transparent substrate having translucency and electrical insulation properties. On the surface as one principal surface on the side facing the array substrate 2 of the glass substrate 32, a first height adjusting layer 33 having a rectangular shape in plan view is provided in a matrix form so as to face the overall reflective display region 21 in each pixel 5 on the glass substrate 3 in a state that the glass substrate 32 is made to face the glass substrate 3 of the array substrate 2.

The first height adjusting layer 33 serves as a structure body having a convex structure for adjusting the cell gap, that is a gap between the array substrate 2 and the counter substrate 31. Furthermore, the first height adjusting layer 33 is formed at a thickness of about, for example, 1.2 μm±0.2 μm by patterning an insulating acrylic resist having photosensitivity. Specifically, the first height adjusting layer 33 has an action of making the cell gap 23 in the reflective display region 21 smaller than the cell gap 24 in the transmissive display region 22.

Furthermore, a counter electrode 34 as a common electrode formed of ITO is laminated on the surface of the glass substrate 32 of the counter substrate 31 so as to cover the first height adjusting layer 33 on the glass substrate 32. The counter electrode 34 is uniformly laminated and formed on the entire surface of the glass substrate 32 containing each first height adjusting layer 33. Accordingly, the first height adjusting layer 33 is formed between the counter electrode 34 and the glass substrate 32 and at the lower side of the counter electrode 34.

Furthermore, on the surface of the counter electrode 34, second height adjusting layer 35 having a slender rectangular shape in plan view which is provided along the longitudinal direction of each pixel 5 on the array substrate 2 and located at the midway point in the lateral direction are provided in a matrix form in a state that the counter substrate is faced to the array substrate 2. The second height adjusting layer 35 is also formed by patterning an insulating acrylic resist having photosensitivity, and it has a film thickness of, for example, about 1.2 μm±0.2 μm. Here, the second height adjusting layer 35 and the first height adjusting layer 33 are respectively formed of resist materials which can be processed in an existing manufacturing process of the array substrate 2.

Still furthermore, the second height adjusting layer 35 has the same thickness as the first height adjusting layer 33, and is laminated on the surface of the counter electrode 34 excluding the portions at the first height adjusting layer 33. That is, the second height adjusting layer 35 is arranged in the region facing the pixel electrode 6 of the array substrate 2, and also provided along the lateral direction of the first height adjusting layer 33 from the midway points of both side edges in the lateral direction of the first height adjusting layer 33.

Accordingly, each of the first height adjusting layer 33 and the second height adjusting layer 35 are designed to be linearly symmetrical with respect to each of the center lines in the longitudinal direction of each pixel 5 and the center line in the lateral direction of each pixel 5. In other words, the first height adjusting layer 33 and the second height adjusting layer 35 are formed to be symmetrical about a point with respect to the center of each pixel 5. That is, the second height adjusting layer 35 is arranged so that the peripheral edge shapes of the peripheral edge portions of the second height adjusting layer 35 are arranged to be symmetrical with each other with respect to the center in the longitudinal direction of the first height adjusting layer 33. Here, the peripheral edge shapes of the peripheral edge portions of the pixel electrode 6 of each pixel 5 of the array substrate 2 are arranged to be symmetrical with each other with respect to the center in the longitudinal direction of the first height adjusting layer 33.

Furthermore, alignment film 38 that is formed by the alignment processing of polyimide and laminated on the surface of the counter electrode 34 so as to cover each second height adjusting layer 35 is formed on the surface of the counter electrode 34. The alignment film 38 is laminated on the entire surface of the counter electrode 34 covering each second height adjusting layer 35. Furthermore, the alignment film 38 is formed by conducting alignment means on the surface of the glass substrate 32 covering each second height adjusting layer 35. Furthermore, the alignment film 38 is an alignment processing layer formed by coating vertical alignment film at a film thickness ranging, for example, from 70 nm to 90 nm. The alignment film 38 is subjected to the alignment processing in a fixed direction, and respectively covers the counter electrode 34 on the glass substrate 32 and the second height adjusting layers 35.

The alignment film 38 and the alignment film 28 of the array substrate 2 are disposed so as to face each other and adhesively attached to each other so that the gap between the alignment film 28 and the alignment film 38 is set to a predetermined space of, for example, 3.65 μm±0.3 μm via a spacer (not shown) as a gap member between the substrates and thus a liquid crystal sealing region A as a liquid crystal injection space can be formed by a sealing member (not shown). Liquid crystal molecules 41 as liquid crystal composition is injected into the liquid crystal sealing region A and sealed, thereby forming the liquid crystal layer 42 as an optical modulation layer. Accordingly, the liquid crystal layer 42 is sandwiched and held between the alignment film 28 of the array substrate 2 and the alignment film 38 of the counter substrate 31. Here, the liquid crystal layer 42 facing the reflective display region 21 and the transmissive display regions 22 of each pixel 5 of the array substrate 2 is supplied with a voltage via the counter electrode 34 respectively facing the reflective display region 21 and the transmissive display regions 22 of each pixel 5.

Furthermore, with respect to the liquid crystal layer 42, the reflection face 14 of the auxiliary capacitance line 13 in the pixel electrode 6 is made to project from the surface of the transparent electrode 15, whereby the cell gap 23 corresponding to the thickness of the liquid crystal layer 42 in the reflective display region 21 is set to be smaller than the cell gap 24 corresponding to the thickness of the liquid crystal layer 42 in each transmissive display region 22. In other words, in the liquid crystal layer 42, the thickness of the reflective display region 21 is set to be smaller than each of the transmissive display regions 22.

Furthermore, liquid crystal material having negative (Nn) dielectric anisotropy is used as the liquid crystal molecules 41 of the liquid crystal layer 42. A vertical alignment type liquid crystal mode in which the liquid crystal molecules 41 are vertically aligned is provided as the liquid crystal cell 1. Furthermore, a one-quarter wave plates 43 and 44 serving as a rectangular flat plate type optical filter is laminated and adhesively attached to the back surface corresponding to the other principal surface of the glass substrates 3 and 32 of each of the array substrate 2 and the counter substrate 31 of the liquid crystal cell 1. Furthermore, linear polarizers 45 and 46 are respectively laminated and adhesively attached onto the one-quarter wave plates 43 and 44.

Here, a polarizing element generally called a circular polarizer is used as the linear polarizers 45 and 46 so that electro-optical switching can be effectively performed in the reflective display region 21 in each pixel 5 of the array substrate 2. As the circular polarizer, a combined structure of a linear polarizing element and a one-quarter wave plate, a structure achieved by laminating a one-quarter wave plate and a half wave plate on a linear polarizing element to suppress the transmissivity conversion of light by wavelength or the like may be used. Furthermore, these linear polarizers 45 and 46 may be added with an optical element having a negative phase difference from the viewpoint of increasing the field-of-view angle.

As a result, the liquid crystal cell 1 switches the thin film transistor 7 of each pixel 5 to apply a video signal to the pixel electrode 6 and control the alignment of the liquid crystal molecules 41 in the liquid crystal layer 42, whereby light reflected from the reflective display region 21 of the pixel electrode 6 in each pixel 5 and light transmitted through the transmissive display region 22 of the pixel electrode 6 are modulated to make a desired image visible.

Next, a method for manufacturing the liquid crystal display device according to the first embodiment will be described.

First, the array substrate 2 on which the pixel electrodes 6 are arranged in a matrix form is prepared.

Then, the first height adjusting layer 33 is formed in a matrix form on the glass substrate 32 of the counter substrate 31 by using a photosensitive acrylic resist so as to face each reflective display region 21 of each pixel 5 of the array substrate 2.

Next, the counter electrode 34 is formed substantially on the entire surface of the glass substrate 32 so as to cover each first height adjusting layer 33.

Thereafter, on the counter electrode 34, the second height adjusting layer 35 is formed by using photosensitive acrylic resist in connection with the respective pixels 5 of the array substrate 2.

At this time, the regions which are located in each pixel electrode 6 on the array substrate 2 and face the first height adjusting layers 33 of the counter substrate 31 facing the pixel electrode 6 are formed of a light-reflecting metal electrode and used as the auxiliary capacitance line 13. Furthermore, the region which is located in the pixel electrode 6 on the array substrate 2 and faces the second height adjusting layer 35 of the counter substrate 31 is formed by the light-transmissible transparent electrodes 15.

Furthermore, the vertical alignment film is coated on the surface of the array substrate 2 and the surface of the counter substrate 31 which are respectively brought into contact with the liquid crystal layer 42, thereby forming the alignment films 28 and 38.

Next, the array substrate 2 and the counter substrate 31 are adhesively attached to each other via the spacer by the sealing member while keeping the gap between the array substrate 2 and the counter substrate 31.

Thereafter, the liquid crystal sealing region A between the array substrate 2 and the counter substrate 31 is filled with the liquid crystal molecules 41 and sealed thereby forming the liquid crystal layer 42.

Furthermore, the one-quarter wave plates 43 and 44 and the linear polarizers 45 and 46 are arranged on the back surfaces of the array substrate 2 and the counter substrate 31 to form the semi-transmissive type liquid crystal cell 1 having the reflective display region 21 and the transmissive display regions 22 in each pixel 5.

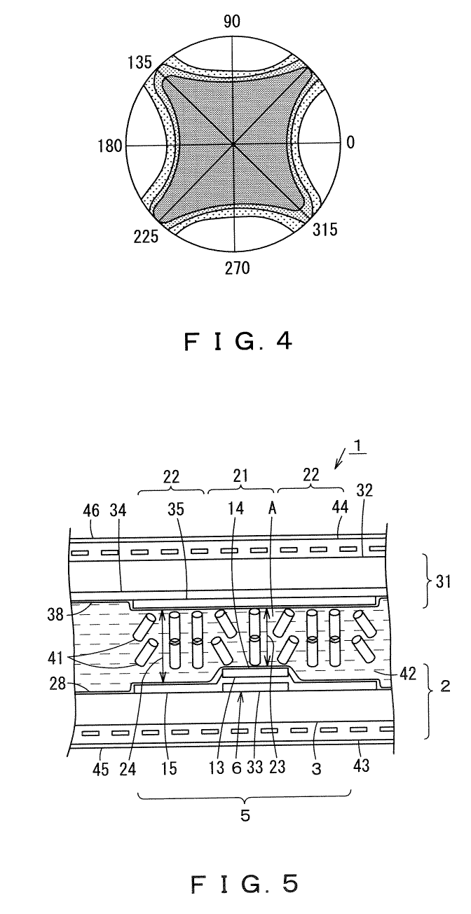

As a result, upon checking the characteristic of the linear polarization state in which the circular polarizer is removed from the linear polarizers 45 and 46 of the liquid crystal cell 1, as shown in FIG. 4, a CR (Computed Radiography) field-of-view angle whose shape is symmetrical in the substantially vertical direction of the liquid crystal cell 1, it was confirmed that the display device has such quality that there is no unevenness of display such as flicker or the like.

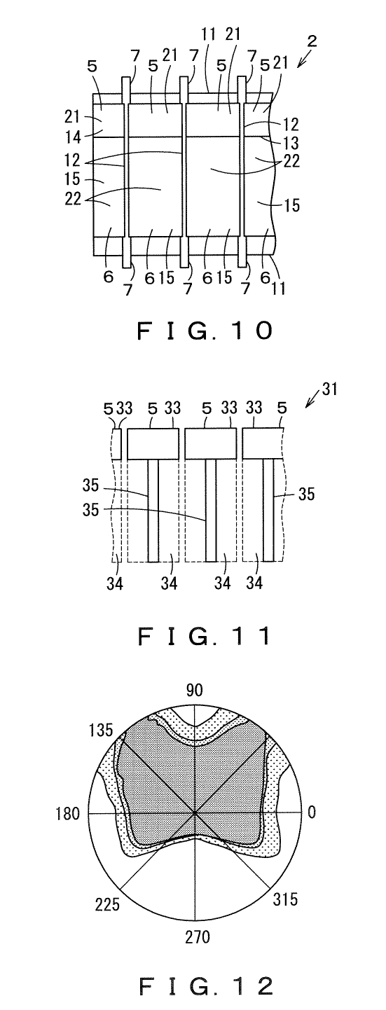

On the other hand, as shown in a comparative example shown in FIG. 9 to FIG. 12, in the case of the liquid crystal cell 1 that an auxiliary capacitance line 13 is wired at one end portion in the longitudinal direction of the pixel electrode 6 of the array substrate 2, the first height adjusting layer 33 is formed so as to face the auxiliary capacitance line 13, the second height adjusting layer 35 is formed at only one side of the first height adjusting layer 33 in the lateral direction, and the reflective display region 21 is formed at only one side of the transmissive display region 22 in each pixel 5, upon checking the characteristic of the linear polarization state in which the circular polarizer is removed from the linear polarizers 45 and 46 of the liquid crystal cell 1, a CR field-of-view angle whose shape is asymmetrical in the vertical direction of the liquid crystal cell 1 is confirmed as shown in FIG. 12, and it is also confirmed that unevenness of display such as flicker or the like occurs.

It is general that the reflective display region 21 of the liquid crystal cell 1 of this comparative example is mainly formed in the light shielding region at the array substrate 2 side because it is unnecessary to transmit light therethrough. Therefore, the first height adjusting layer 33 serving as the structure body for the reflective display regions 21 is frequently formed at the positions facing opaque metal wire portions such as the scanning lines 11, the auxiliary capacitor lines 13, etc., on the array substrate 2. That is, each reflective display region 21 is generally formed at one end portion in the longitudinal direction of the pixel electrode 6 at which the scanning line 11 or the auxiliary capacitance line 13 is disposed.

Here, in the conventional liquid crystal cell 1 in which the transmissive display region 22 is arranged at only one end or only the other end in the longitudinal direction of the pixel 5 with respect to the reflective display region 21 of the array substrate 2, the motion of the liquid crystal molecules 41 is easily affected by the uneven shape of the counter electrode 34 which is caused by the first height adjusting layer 33. Therefore, it is necessary to consider both the motion of the liquid crystal molecules 41 caused by the pixel electrode 6 of the reflective display region 21 and the motion of the liquid crystal molecules 41 caused by the alignment control of MVA.

That is, when the first height adjusting layer 33 for making the thickness of the liquid crystal layer 42 in the reflective display region 21 smaller than the thickness of the transmissive display region 22 is formed below the counter electrode 34 of the counter substrate 31, the counter electrode 34 is designed to have a convex structure because of formation of the first height adjusting layer 33. With respect to the counter electrode 34, the electric field generally concentrates on the portion of the convex structure, and thus at the peripheral edge of the reflective display region 21 in which the counter electrode 34 has the convex structure, the liquid crystal molecules 41 move in a direction to fall over to the center of the reflective display region 21. On the other hand, with respect to the transmissive display region 22, the liquid crystal molecules 41 move in a direction to fall over to the center of the transparent electrode 15 by the electric field caused by the leaking electric field formed at the peripheral edge of the transparent electrode 15 as in the case of the reflective display region 21 facing the convex structure of the counter electrode 34.

However, the effect of the concentration of the electric field on the peripheral edge of the reflective display region 21 is dominant at the boundary portion between the transmissive display region 22 and the reflective display region 21, and thus, as shown in FIG. 9, the motion of the liquid crystal molecules 41 in the transmissive display region 22 becomes asymmetrical. The display performance of the liquid crystal cell 1 such as the alignment stability, the field-of-view angle, etc., is affected by the asymmetrical motion of the liquid crystal molecules 41. Therefore, the conventional liquid crystal cell 1 in which the reflective display region 21 is formed at only one end or only the other end in the longitudinal direction of the pixel electrode 6 has a risk that the field-of-view angle becomes asymmetrical or unevenness of display such as flicker or the like occurs due to a reduction in the alignment stability.

Therefore, in the liquid crystal cell 1 of the first embodiment, the transmissive display regions 22 are disposed at both sides of the reflective display region 21 of the pixel electrode 6 in each pixel 5 of the array substrate 2 so as to sandwich the reflective display region 21 therebetween as described above. As a result, even when the first height adjusting layer 33 for making the thickness of the liquid crystal layer 42 in the reflective display region 21 of each pixel 5 of the liquid crystal cell 1 smaller than the thickness of the transmissive display regions 22 is formed below the counter electrode 34 of the counter substrate 31, the motion of the liquid crystal molecules 41 at the peripheral edge of the reflective display region 21 in which the counter electrode 34 has the convex structure and the motion of the liquid crystal molecules 41 at the peripheral edge of each transmissive display region 22 are symmetrical at both sides of the reflective display region 21 as shown in FIG. 1 because the transmissive display regions 22 are provided at both sides of the reflective display region 21 of each pixel 5.

Accordingly, the asymmetrical property of the field-of-view angle and unevenness of display such as flicker or the like in conjunction with a reduction in the alignment stability caused in the conventional liquid crystal cell hardly occurs in the conventional liquid crystal cell 1. Accordingly, the alignment stability of the liquid crystal in each of the plurality of pixels 5 can be enhanced, and defects such as unevenness of display, etc., caused by fluctuation of the alignment of the liquid crystal molecules 41 in the liquid crystal layer 42 can be avoided, so that the asymmetrical property of the field-of-view angle can be avoided. Therefore, the asymmetrical property of the field-of-view angle in each pixel 5 of the liquid crystal cell 1 can be secured, and the general characteristic of the image quality level of the liquid crystal cell 1 can be enhanced. Accordingly, the display quality level of the liquid crystal cell 1 can be enhanced, and the semi-transmissive type liquid crystal cell 1 having the wide field-of-view angle can be easily provided.

Furthermore, the transmissive display regions 22 are provided at both sides of the reflective display region 21 of each pixel 5. Therefore, it is unnecessary to increase the cost due to an increase in the number of processes and the number of masks to manufacture the liquid crystal cell 1 and to increase the items for film thickness management of the first height adjusting layer 33 to control the thickness of the liquid crystal layer 42 with accuracy. Accordingly, the semi-transmissive type liquid crystal cell 1 having an excellent field-of-view angle characteristic can be manufactured with high yield without changing the conventional manufacturing process.

Furthermore, the second height adjusting layer 35 having the same thickness as the first height adjusting layer 33 is formed on the counter electrode 34 of the counter substrate 31 which face the respective transmissive display regions 22 located at both sides of the reflective display region 21 in each pixel 5 of the array substrate 2. As a result, the thickness of the liquid crystal layer 42 in the transmissive display region 22 is substantially equal to the thickness of the liquid crystal layer 42 in the reflective display region 21, whereby the motion of the liquid crystal molecules 41 in each transmissive display region 22 due to the difference in the thickness of the liquid crystal layer 42 between the transmissive display region 22 and the reflective display region 21 can be prevented from becoming asymmetrical. Accordingly, occurrence of the asymmetrical property of the field-of-view angle caused by the asymmetrical motion of the liquid crystal molecules 41 and the unevenness of display such as flicker caused by the reduction in the alignment stability can be more reliably prevented, and thus the display quality of the liquid crystal cell 1 can be further enhanced.

Here, the vertical alignment type liquid crystal display system in which the liquid crystal molecules 41 having negative dielectric anisotropy are vertically aligned is used as the liquid crystal display mode of the liquid crystal cell 1, and particularly, the wide field-of-view angle mode as the MVA system is adopted. Accordingly, the manufacturing process of the horizontal alignment type liquid crystal cell 1 represented by the TN (Twist Nematic) type, the IPS type, etc., which have conventionally been in practical use, that is, the rubbing treatment of the manufacturing process can be omitted by adopting the liquid crystal cell 1 having the vertical alignment type liquid crystal display mode using the MVA system. Accordingly, generation of dust in the rubbing treatment step of the process of manufacturing the liquid crystal cell 1, defects such as unevenness of rubbing, etc., can be avoided. Therefore, the productivity of the liquid crystal cell 1 can be enhanced, and the semi-transmissive type liquid crystal cell 1 having an excellent field-of-view angle characteristic can be manufactured with high yield.

Furthermore, according to the MVA system, the tilt direction of the liquid crystal molecules 41 in the liquid crystal layer 42 is controlled by the second height adjusting layer 35 formed on the counter electrode 34 of the counter substrate 31 and the outer peripheral edge (fringe-field) as the cut-out portion of the counter electrode 34. Accordingly, formation of the second height adjusting layer 35 on the counter electrode 34 of the counter substrate 31 as described above enables the control of the tilt direction of the liquid crystal molecules 41 by the second height adjusting layer 35 facing the transparent electrode 15 in each pixel 5 of the array substrate 2. At this time, the second height adjusting layer 35 is constructed by patterning using a photosensitive resist, whereby the tilt direction of the liquid crystal molecules 41 at the portions facing the transmissive display region 22 in each pixel 5 of the array substrate 2 can be controlled to any direction.

In the reflective display region 21 of each pixel 5, the first height adjusting layer 33 is formed below the counter electrode 34 for applying a voltage to the liquid crystal layer 42. Therefore, the thickness of the liquid crystal layer 42 in the reflective display region 21 is controlled by the convex structure formed at the portion of the counter electrode 34 which faces the reflective display region 21, thereby performing reflective display. Furthermore, the first height adjusting layer 33 can be designed to have a desired shape by using a photosensitive resist or using wire materials of the scanning lines 11 or signal lines 12 of the array substrate 2.

With respect to the convex structure of the counter electrode 34 in the reflective display region 21 of each pixel 5 of the liquid crystal cell 1, it is important to match it with the motion of the liquid crystal molecules 41 which is caused by the peripheral edge portion of each pixel electrode 6 of the array substrate 2 of the liquid crystal cell 1. Therefore, it is preferable that the shape of the peripheral edge portion of the pixel electrode 6 and the shape of the peripheral edge portion of the convex structure of the counter electrode 34 of the reflective display region 21 are symmetrically arranged with respect to the center in the longitudinal direction of the first height adjusting layer 33. That is, the arranged state in which the first height adjusting layer 33 faces the center in the longitudinal direction of the pixel electrode 6 is most preferable. However, from a practical standpoint, the transmissive display regions 22 may be arranged at both sides of the reflective display region 21.

Furthermore, the polar angle as the tilt direction of the liquid crystal molecules 41 and the azimuth angle as the in-plane direction of the liquid crystal molecules 41 are simultaneously controlled, and thus a minute uneven shape can be provided to the surface of the counter electrode 34 facing the reflective display region 21. With respect to the minute uneven shape concerned, from the viewpoint of enhancing the uniformity of alignment, it is most preferable to set the minute uneven shape to a pattern whose period (that is, interval) ranges, for example, from not less than 3 μm to not more than 15 μm. However, from the viewpoint of the balance of the voltage applied to the liquid crystal layer 42, the transmissivity, the image quality, etc., the period of the minute uneven shape is not limited to the period of the pattern described above, and other patterns may be used.

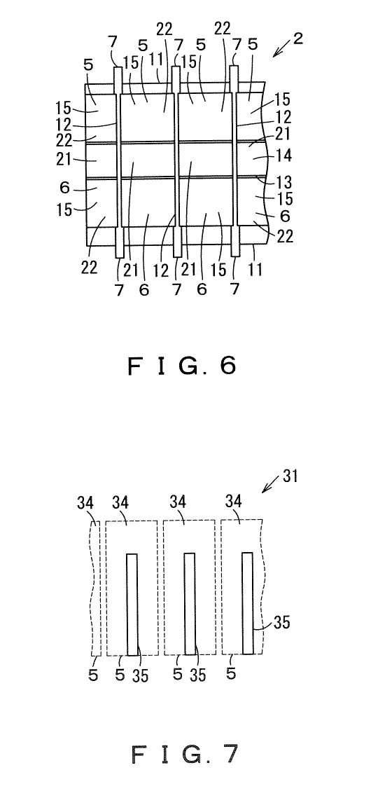

In the above-described first embodiment, the liquid crystal cell 1 in which the first height adjusting layer 33 is formed below the counter electrode 34 of the counter substrate 31 is described. However, the present invention may be implemented by a liquid crystal cell 1 in which the first height adjusting layer 33 is formed below the auxiliary capacitance line 13 of the array substrate 2 as in the case of a second embodiment shown in FIG. 5 to FIG. 8. According to this liquid crystal cell 1, the first height adjusting layer 33 of 1.5 μm±0.2 μm in height is laminated in the reflective display region 21 of each pixel 5 on the glass substrate 3 of the array substrate 2, for example. The first height adjusting layer 33 is provided at the midway point in the longitudinal direction of each pixel 5 so as to extend along the lateral direction of each pixel 5 across the entire lateral direction.

Furthermore, the transparent electrode 15 is provided on the glass substrate 3 of the array substrate 2 so as to cover the first height adjusting layer 33. The transparent electrode 15 is laminated substantially across the entire region in each pixel 5. That is, the transparent electrode 15 is provided to the reflective display region 21 and the transmissive display regions 22 at both sides of the reflective display region 21 in each pixel 5. The auxiliary capacitance line 13 is laminated so as to face the first height adjusting layer 33 on the transparent electrode 15. The auxiliary capacitance line 13 has the same width as the first height adjusting layer 33. Accordingly, the auxiliary capacitance line 13 is coated covering the first height adjusting layer 33. Furthermore, the alignment film 28 is laminated so as to respectively cover the auxiliary capacitance line 13 and the transparent electrode 15.

The counter electrode 34 is laminated on the entire surface of the glass substrate 32 of the counter substrate 31, and the second height adjusting layer 35 is laminated on the counter electrode 34. The second height adjusting layer 35 is formed so as to extend from the midway point in the lateral direction of one end edge in the longitudinal direction of the pixel electrode 6 along the longitudinal direction of the pixel electrode 6 to a position near the other end edge in the longitudinal direction of the pixel electrode 6, and formed in a slender rectangular shape in plan view. Furthermore, the alignment film 38 is laminated so as to respectively cover the second height adjusting layer 35 and the counter electrode 34.

The counter substrate 31 and the array substrate 2 are adhesively attached via a spacer by a sealing member so that a gap of about 3.5 μm±0.3 μm is formed between the alignment film 28 of the array substrate 2 and the alignment film 38 of the counter substrate 31.

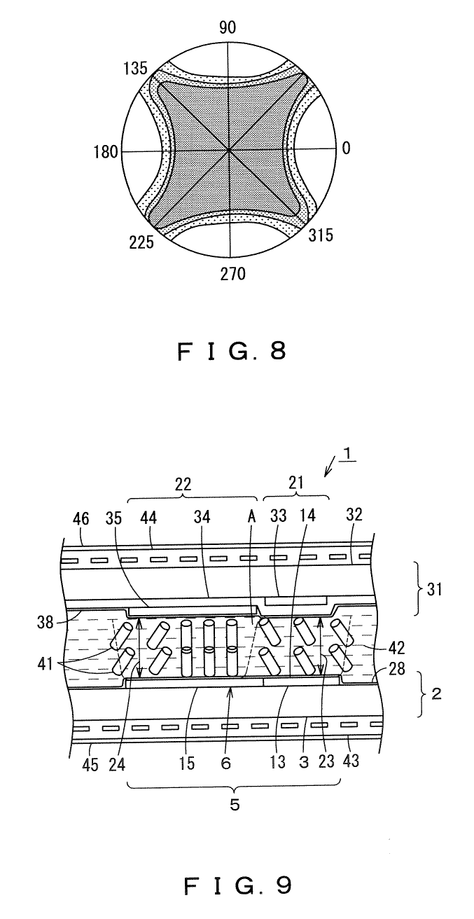

As a result, upon checking the characteristic of the linear polarization state under which the circular polarizer is removed from the linear polarizers 45 and 46 of the liquid crystal cell 1, a CR field-of-view angle whose shape is symmetrical in the substantially vertical direction of the liquid crystal cell 1 as shown in FIG. 8 can be confirmed as in the case of the first embodiment, and also the quality level in which there is no unevenness of display such as flicker or the like can be confirmed. Therefore, the same action and effect as the first embodiment can be achieved.

In the above-described embodiments, the pixel electrode 6 in each pixel 5 is controlled by the thin film transistor 7. However, the pixel electrode 6 may be controlled by a switching element other than the transistor 7, such as a thin film diode or the like. Furthermore, the present invention can be applied to a simple matrix type liquid crystal cell 1 other than the active matrix type liquid crystal cell 1.

What is claimed is:

1. A liquid crystal display device comprising:
an array substrate having a light-transmissible substrate, a plurality of pixels provided in a matrix form on one principal surface of the light-transmissible substrate, a reflective region that is provided to each of the plurality of pixels and visible by using reflection of light, and transmittance regions that are provided at both sides of the reflective region so as to sandwich the reflective region therebetween and visible by using transmission of light;
a counter substrate having a light-transmissible substrate that is disposed so as to face the one principal surface of the light-transmissible substrate of the array substrate; and
a liquid crystal layer that is interposed between the array substrate and the counter substrate and has a thickness in the reflective region that is smaller than that of the transmittance regions.

2. The liquid crystal display device according to claim 1, wherein the liquid crystal layer is formed so that the thickness in the reflective region is made smaller than the thickness in each transmittance region by an adjusting layer provided to any one of the array substrate and the counter substrate.

3. The liquid crystal display device according to claim 2, wherein the counter substrate comprises a counter electrode disposed on one principal surface of the light-transmissible substrate, and the adjusting layer is provided between the counter electrode and the light-transmissible substrate.

4. The liquid crystal display device according to claim 1, wherein the counter substrate comprises a first adjusting layer provided on one principal surface of the light-transmissible substrate, a counter electrode provided on the first adjusting layer and the light-transmissible substrate, and second adjusting layers provided at both sides of the first adjusting layer on the counter electrode so as to sandwich the first adjusting layer therebetween,
the reflective region is a region where the first adjusting layer is located, and
the transmittance region is a region where the second adjusting layers are located.

5. The liquid crystal display device according to claim 4, wherein the second adjusting layers are provided so as to be symmetrical with respect to the first adjusting layer.

6. The liquid crystal display device according to claim 1, wherein each of the plurality of pixels is provided in an elongated form,
the reflective region is provided at the midway point in the longitudinal direction of each pixel, and
the transmittance region is provided at both sides of the reflective region along the longitudinal direction.

7. The liquid crystal display device according to claim 1, wherein the transmittance regions are provided symmetrically with respect to the reflective region.

8. The liquid crystal display device according to claim 1, wherein the array substrate comprises a capacitance line provided on one principal surface of the light-transmissible substrate, and
the reflective region is a region where the capacitance line is located.

9. The liquid crystal display device according to claim 8, wherein the capacitance line has an incident-light reflecting reflection face provided on the surface thereof.

10. The liquid crystal display device according to claim 8, wherein the array substrate comprises transparent electrodes that are provided at both sides of the capacitance line on one principal surface of the light-transmissible substrate so as to sandwich the capacitance line therebetween, and
the transmittance regions are regions where the transparent electrodes are located.

11. The liquid crystal display device according to claim 10, wherein the transparent electrode is formed to be smaller in thickness than the capacitance line.

12. The liquid crystal display device according to claim 10, wherein the capacitance line is provided so as to face the first adjusting layer, and
the transparent electrodes are provided symmetrically with respect to the capacitance line so as to face the second adjusting layers.
